(19) United States
(12) Patent Application Publication
(10) Pub. No.: US 2024/0381032 A1
(43) Pub. Date: Nov. 14, 2024

(54) DOUBLE GAP DOUBLE COIL DRIVEN SPEAKER

(71) Applicant: JULUEN ENTERPRISE CO., LTD., New Taipei City (TW)

(72) Inventors: Ching-Hui HUANG, New Taipei City (TW); Bing-Qi CHEN, New Taipei City (TW); Sze-Yi CHEN, New Taipei City (TW); Po-Chang WU, New Taipei City (TW)

(73) Assignee: JULUEN ENTERPRISE CO., LTD., New Taipei City (TW)

(21) Appl. No.: 18/314,119

(22) Filed: May 8, 2023

(51) Int. Cl. H04R 9/06; H04R 7/22; H04R 9/04

(52) U.S. Cl. CPC H04R 9/06; H04R 7/22; H04R 9/046; H04R 2209/041

(57) ABSTRACT

A double gap double coil driven speaker includes a diaphragm, a permanent magnet having a magnetization, and a magnetic flux conducting device having a magnetic flux conducting path. The magnetic flux conducting device and the permanent magnet together form a magnetic flux loop, wherein the magnetic flux loop has two gaps, and directions of magnetic fields generated in the two gaps are opposite to each other. The speaker further includes a voice coil having two coils wound on an outer surface of the voice coil and the voice coil having one end connected to the diaphragm, wherein the two coils are respectively accommodated in the two gaps. When the two coils conduct currents, the voice coil is displaced to push the diaphragm, wherein, relative to a common cross section of the two gaps, the currents respectively flowing through the two coils are in opposite directions.

### FIELD OF INVENTION

The present invention relates to a speaker, especially a double gap double coil driven speaker.

### BACKGROUND OF THE INVENTION

Generally, the sound wave frequency of an outdoor safety alarm is below 2000 Hz, at which sound is less likely to be absorbed by the atmosphere, easier to bypass obstacles such as vehicles and buildings, able to transmit farther distances, and more easily to penetrate into interiors of vehicles. For example: for an ambulance siren, the sound wave frequency of the safety alarm is between 2000 Hz and 400 Hz and is repeating at a fixed cycle, wherein in one cycle the safety alarm tunes down continuously from 2000 Hz to 400 Hz and then up continuously from 400 Hz to 2000 Hz. In terms of volume of sound, the ambulance siren must be able to overwhelm the noises from the environment, and hence the siren is also required to have a targeted output of a significant sound volume.

In view of the aforementioned, when installing a speaker of a safety alarm in a place with spatial constraints, such as a vehicle, the physical size of the speaker is also constrained. Therefore, how to achieve a targeted output sound volume with a constrained physical size for a safety alarm speaker has been a focus of ongoing efforts in technical fields of the present invention.

### SUMMARY OF THE INVENTION

In order to solve the above problems, the present invention provides a double gap double coil driven speaker, including:
a diaphragm;
a permanent magnet, having a magnetization;
a magnetic flux conducting device, having a magnetic flux conducting path, the magnetic flux conducting device and the permanent magnet together forming a magnetic flux loop; wherein the magnetic flux loop has two gaps, and directions of magnetic fields generated in the two gaps are opposite to each other;
a voice coil, having two coils wound on an outer surface of the voice coil, and the voice coil having one end connected to the diaphragm; wherein
the two coils are respectively accommodated in the two gaps; when the two coils conduct currents, the voice coil is displaced to push the diaphragm, wherein, relative to a common cross section of the two gaps, the currents respectively flowing through the two coils are in opposite directions.

Preferably, a speaker including the above-mentioned double gap double coil driven speaker further includes a U-shaped sound channel through which sound propagates to the exterior.

As described above, the double gap double coil driven speaker of the present invention has a magnetic flux loop with two gaps respectively producing two magnetic fields interacting with two coils on a voice coil to generate two forces in the same direction to push the diaphragm; therefore, the physical size of the double gap double coil driven speaker of the present invention is not significantly increased for having two coils (instead of just one coil), and the sound volume of the double gap double coil driven speaker of the present invention can be almost doubled. The double gap double coil driven speaker of the present invention can also prolong a path of sound propagation to enhance resonances of low-frequency sound. Accordingly, the double gap double coil driven speaker of the present invention can achieve the purposes of the invention to reach a targeted output sound volume with a constrained physical size.

### BRIEF DESCRIPTION OF THE DRAWINGS

FIG. 1 shows a schematic view of the double gap double coil driven speaker of the present invention;

FIG. 2 shows an exploded view of the double gap double coil driven speaker of the present invention;

FIG. 3 shows a schematic bottom view of a fixing cap of the present invention;

FIG. 4 shows a top view of the double gap double coil driven speaker of the present invention;

FIG. 5 shows a cross-sectional view of the double gap double coil driven speaker of the present invention;

FIG. 6 shows another cross-sectional view of the double gap double coil driven speaker of the present invention;

FIG. 7 shows a cross-sectional view of a diaphragm of the double gap double coil driven speaker of the present invention; and

FIG. 8 shows a schematic view of a power line fixing structure of the double gap double coil driven speaker of the present invention.

### DETAILED DESCRIPTION OF THE INVENTION

In the following, the technical solutions in the embodiments of the present invention will be clearly and fully described with reference to the drawings in the embodiments of the present invention. Obviously, the described embodiments are only a part of, not all of, the embodiments of the present invention. Based on the embodiments of the present invention, all other embodiments obtained by a person of ordinary skill in the art without creative efforts shall fall within the protection scope of the present invention.

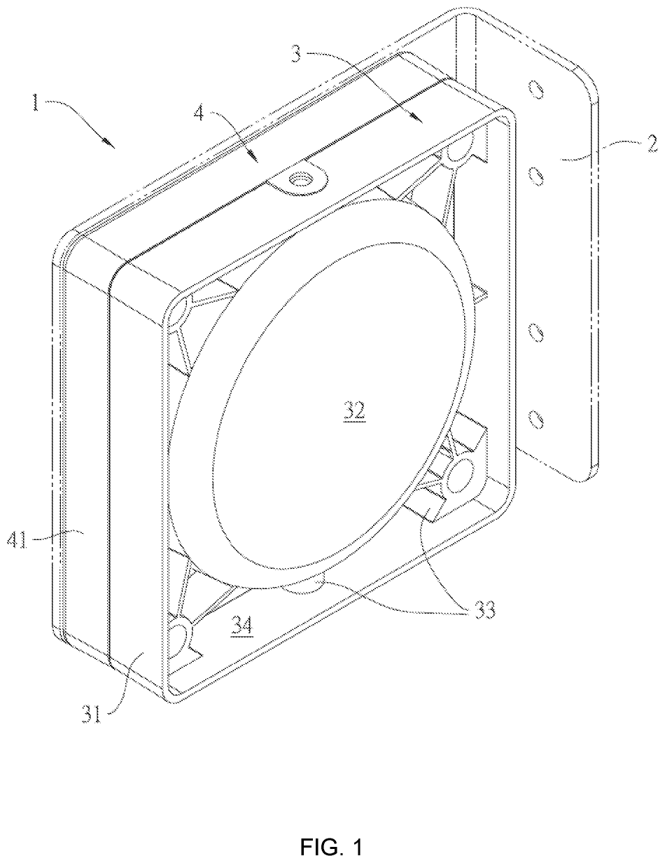

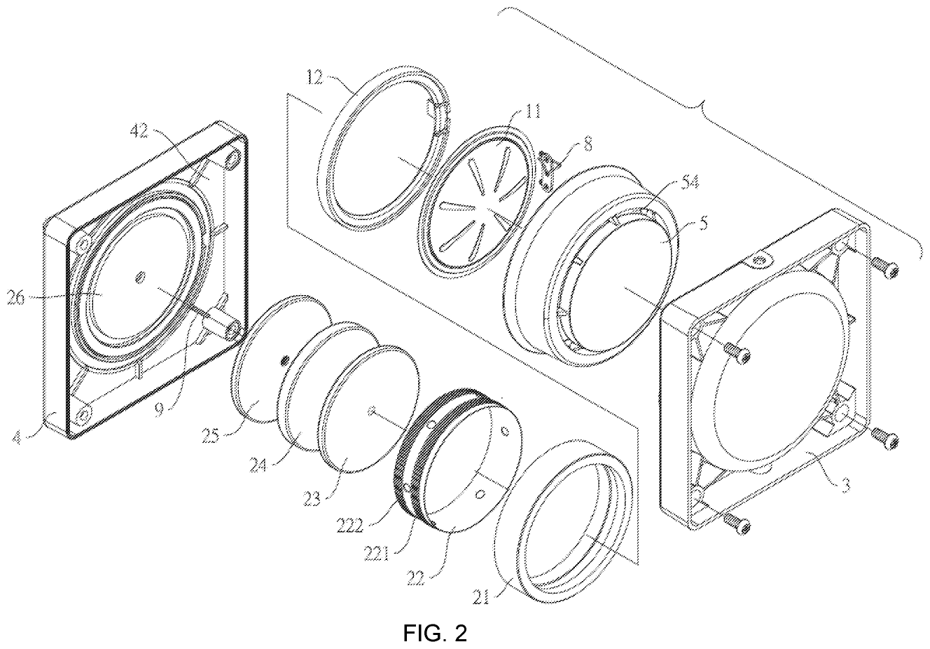

Please refer to FIGS. 1 and 2. FIGS. 1 and 2 respectively show the appearance and the exploded view of the double gap double coil driven speaker 1 of the present invention. The double gap double coil driven speaker 1 of the present invention includes a bottom plate 2, a top shell 3, a bottom shell 4, a fixing cap 5, a power line fixing structure 8, a screw 9, a diaphragm 11, a fixing annular frame 12, a magnetic flux conducting ring 21, a voice coil 22, a top magnetic flux conducting plate 23, a permanent magnet 24, a bottom magnetic flux conducting plate 25, and a fixing bottom plate 26.

The bottom plate 2 is an L-shaped plate, and the top shell 3 and the bottom shell 4 are superimposed and fixed on a surface of the bottom plate 2. The top shell 3 has a top shell frame 31, a top shell cover 32 and a plurality of connecting pieces 33. The top shell frame 31 is disposed around the periphery of the top shell 3, the top shell cover 32 is disposed in the top middle of the top shell 3, the plurality of connecting pieces 33 connect the top shell frame 31 and the top shell cover 32, so as to support the top shell cover 32. Between the top shell frame 31 and the top shell cover 32 is largely a void 34 except for the plurality of connecting pieces 33. The plurality of connecting pieces 33 and the void 34 are symmetrically distributed between the top shell frame 31 and the top shell cover 32. The top shell cover 32 is a cylindrical shell with an open accommodating space 36 for directly covering and accommodating the fixing cap 5. The bottom shell 4 has a bottom shell frame 41 and a bottom surface 42, and the bottom surface 42 has a central circular hole (not shown in figures) which is configured to fix the fixing bottom plate 26.

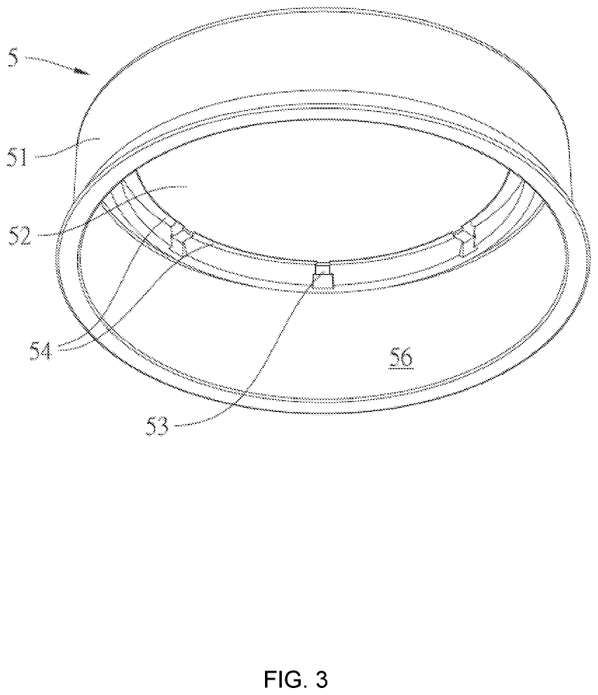

Please refer to FIG. 3, which shows the bottom view of the fixing cap 5 of the present invention. The fixing cap 5 has an annular border frame 51, a dome 52 and a plurality of connecting bars 53. The annular border frame 51 is disposed on the periphery of the fixing cap 5, the dome 52 is disposed above the annular border frame 51, and the plurality of connecting bars 53 connect the annular border frame 51 and the dome 52 to support the dome 52. Between the annular border frame 51 and the dome 52 is largely a void 54 except for the plurality of connecting bars 53. The plurality of connecting bars 53 and the void 54 are symmetrically disposed between the annular border frame 51 and the dome 52. The annular border frame 51 is an annular shell, the dome 52 is a circular cover, and the annular border frame 51 and the dome 52 together form an open accommodating space 56 for directly covering and accommodating the fixing annular frame 12, the magnetic flux conducting ring 21, the voice coil 22 and part of the fixing bottom plate 26.

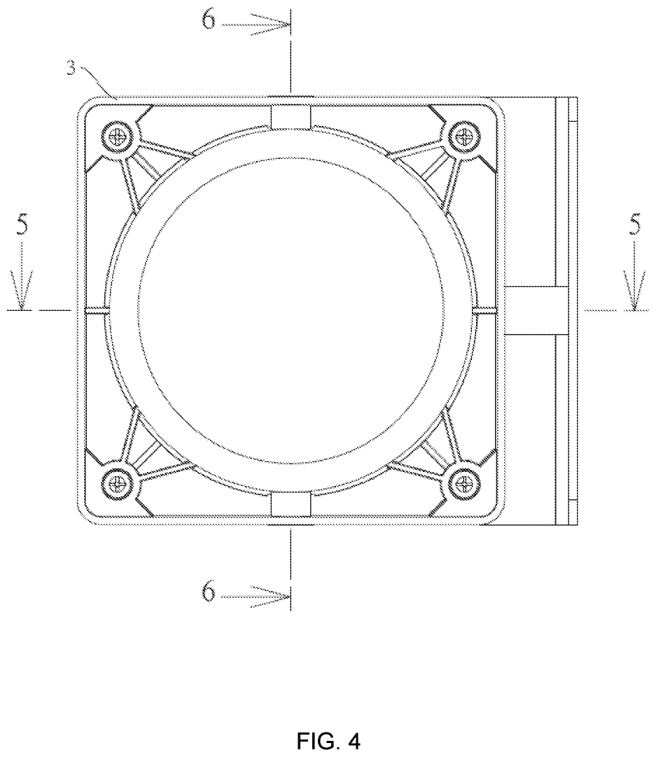

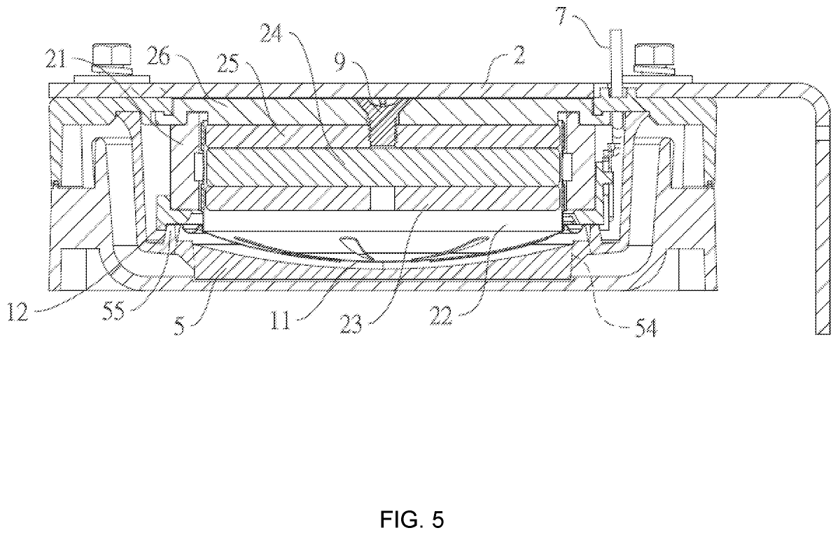

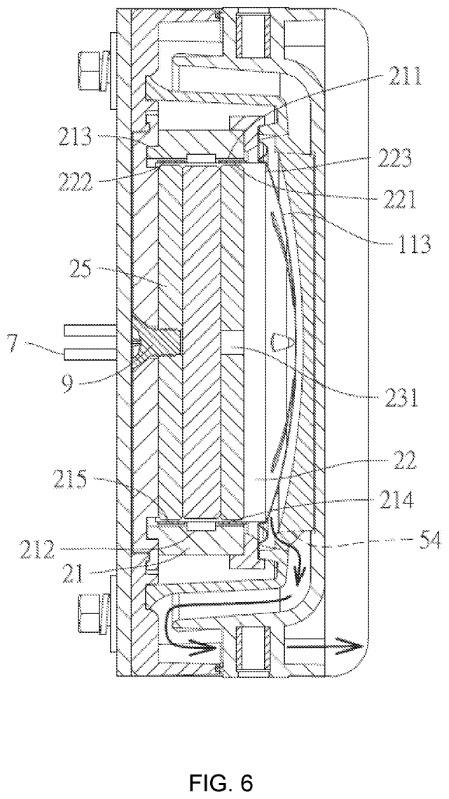

Please refer to FIGS. 4 to 6. FIG. 4 shows a top view of the double gap double coil driven speaker 1 of the present invention. FIGS. 5 to 6 show cross-sectional views of the double gap double coil driven speaker 1 of the present invention respectively along a cross section 5-5 and a cross-section 6-6. As shown in FIG. 5: the fixing annular frame 12, the magnetic flux conducting ring 21 and the fixing bottom plate 26 are sequentially stacked in the accommodating space 56 of the fixing cap 5, and an inner edge 55 of the fixing cap 5 is disposed on an annular surface of the fixing annular frame 12. The fixing annular frame 12 is a ring, the magnetic flux conducting ring 21 is a ring, and the fixing bottom plate is a disc. The fixing cap 5, the fixing annular frame 12, the magnetic flux conducting ring 21 and the fixing bottom plate 26 are sequentially stacked to form an action space for accommodating the diaphragm 11, the voice coil 22, the top magnetic flux conducting plate 23, the permanent magnet 24 and the bottom magnetic flux conducting plate 25. The top magnetic flux conducting plate 23, the permanent magnet 24, and the bottom magnetic flux conducting plate 25 are all discs and are sequentially stacked and fixed on the fixing bottom plate 26, wherein the bottom magnetic flux conducting plate 25 is fastened with the fixing bottom plate 26 via a screw 9. The voice coil 22 is disposed in an annular gap between the three of the top magnetic flux conducting plate 23, the permanent magnet 24, and the bottom magnetic flux conducting plate 25, and the two of the fixing annular frame 12 and the magnetic flux conducting ring 21.

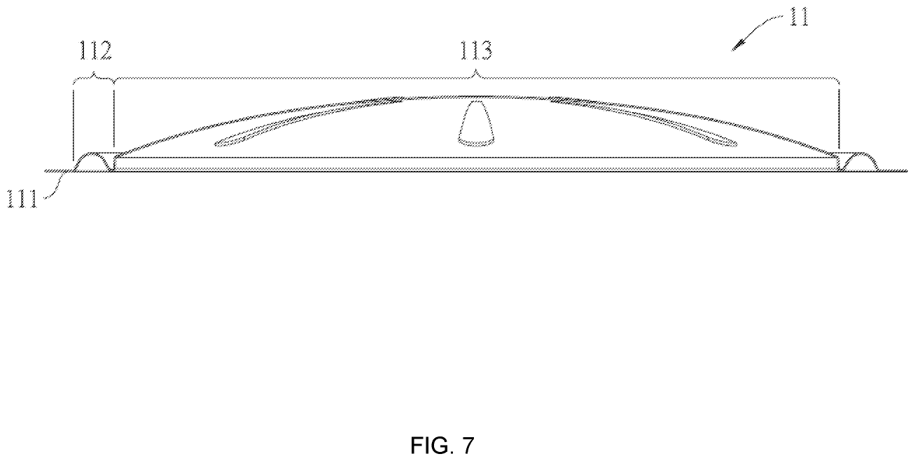

Please refer to FIG. 7. FIG. 7 shows a cross-sectional view of the diaphragm 11 of the double gap double coil driven speaker 1 of the present invention. The diaphragm 11 is in the shape of a round bowl and has a peripheral annular part 111, a wavy annular part 112 and a central bowl part 113 disposed sequentially from periphery to center. And, as shown in FIG. 6, the peripheral annular part 111 of the diaphragm 11 is clamped by and between the inner edge 55 of the fixing cap 5 and the annular surface of the fixing annular frame 12. The annular joint of the wavy annular part 112 and the central bowl part 113 is in direct contact with a top edge 223 of the voice coil 22, and a space above the wavy annular part 112 and the central bowl part 113 of the diaphragm 11 is a part of the action space. The wavy annular part 112 is elastically stretchable, so when the diaphragm 11 is moved by displacement of the voice coil 22, the diaphragm 11 is in turn being pushed to agitate the air to produce sound.

The magnetic flux conducting ring 21 has an inner ring side on which a first protruding annular surface 211, an indenting annular surface 212 and a second protruding annular surface 213 are sequentially disposed; the first protruding annular surface 211 is close to one end of the magnetic flux conducting ring 211, the second protruding annular surface 213 is close to the other end of the magnetic flux conducting ring 211, and the indenting annular surface 212 is between the first protruding annular surface 211 and the second protruding annular surface 211. A gap between the first protruding annular surface 211 of the magnetic flux conducting ring 21 and the top magnetic flux conducting plate 23 is defined as a first annular gap 214, and the gap between the second protruding annular surface 213 of the magnetic flux conducting ring 21 and the bottom magnetic flux conducting plate 25 is defined as a second annular gap 215. The voice coil 22 is a cylindrical sheet, and a first coil winding 221 and a second coil winding 222 are separately wound on an outer surface of the voice coil 22. The first coil winding 221 is disposed in the first annular gap 214, that is, the first coil winding 221 directly faces both the first protruding annular surface 211 of the magnetic flux conducting ring 21 and the top magnetic flux conducting plate 23. The second coil winding 222 is disposed in the second annular gap 215, that is, the second coil winding 222 directly faces both the second protruding annular surface 213 of the magnetic flux conducting ring 21 and the bottom magnetic flux conducting plate 25.

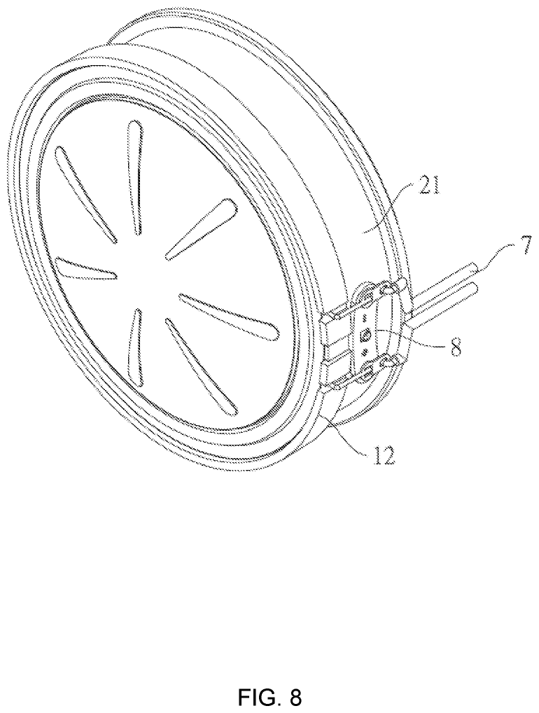

Both the first coil winding 221 and the second coil winding 222 of the voice coil 22 are used to conduct currents, and the first coil winding 221 and the second coil winding 222 are both connected in parallel and connected to the exterior via a set of power lines 7 as shown in FIG. 6. Please refer to FIG. 8: FIG. 8 shows the power line fixing structure 8 of the double gap double coil driven speaker 1 of the present invention. The power line fixing structure 8 is disposed on the outer surface of the magnetic flux conducting ring 21, a pair of power lines 7 connects the first coil winding 221 and the second coil winding 222 in parallel, is fixed on the voice coil 22 near the top edge 223, then passes through two notches of the fixing annular frame 12 and is fixed to the power line fixing structure 8, and then the pair of power lines 7 passes through a hole of the bottom plate 2 and extends to the outer side of the double gap double coil driven speaker 1 of the present invention (as shown in FIG. 6).

In one embodiment, the center of the top magnetic flux conducting plate 23 also has a circular hole 231 (as shown in FIG. 6).

The permanent magnet 24 can be a ferrite magnet (i.e. a ceramic material with iron oxide as its main component), an Aluminum Nickle cobalt (AlNiCo) iron alloy magnet, or a rare earth magnet (such as a Neodymium Iron Boron (NdFeB) magnet or a Samarium Cobalt (SmCo) magnet), wherein the rare earth magnet is the strongest permanent magnet. The permanent magnet 24 has a magnetization.

The magnetic flux conducting ring 21, the top magnetic flux conducting plate 23 and the bottom magnetic flux conducting plate 25 are made of amorphous ferromagnetic alloys with high magnetic permeability. Said amorphous ferromagnetic alloys are made of transition metals such as iron, cobalt, and nickel, and other elements such as boron, carbon, silicon, phosphorus, or aluminum. The magnetic flux conducting ring 21, the top magnetic flux conducting plate 23 and the bottom magnetic flux conducting plate 25 can easily conduct magnetic flux generated by the magnetization of the permanent magnet 24. A magnetic flux conduction path starts from the N pole of the permanent magnet 24 (which can be directed towards the top magnetic flux conducting plate 23, but the present invention is not limited to this), then through the top magnetic flux conducting plate 23, then through the first annular gap 214, then through the magnetic flux conducting ring 21, then through the second annular gap 215, and then through the bottom magnetic flux conducting plate 25, and finally ends at the S pole of the permanent magnet 24. Therefore, the top magnetic flux conducting plate 23, the first annular gap 214, the magnetic flux conducting ring 21, the second annular gap 215 and the bottom magnetic flux conducting plate 25 constitute a magnetic flux conducting device. And the magnetic flux conducting device has a magnetic flux conducting path. The magnetic flux conducting device and the permanent magnet 24 together form a magnetic flux loop. Wherein a product of an air permeability and a sum of magnetic field strengths respectively generated in the first annular gap 214 and the second annular gap 215 is equivalent to the magnetic flux density generated by the magnetization of the permanent magnet.

The dimensions of the first annular gap 214 and the second annular gap 215 are the same, so that the magnetic fields passing through the first annular gap 214 and the second annular gap 215 have opposite directions and the same magnitude. The sizes, materials, winding methods and winding numbers of the first coil winding 221 and the second coil winding 222 are the same, but the invention is not limited to this. The first coil winding 221 and the second coil winding 222 are connected in parallel, so that the magnitudes of the currents conducting in the first coil winding 221 and the second coil winding 222 are the same, and at the same time, the directions of the currents respectively conducting in the first coil winding 221 and the second coil winding 222 are configured to be opposite to each other, for example, in FIG. 6, the paper surface of FIG. 6 can be regarded as a common cross section of both the first annular gap 214 and the second annular gap 215. On the right side of FIG. 6, if the current of the first coil winding 221 flows out of the paper surface, the current of the second coil winding 222 must be configured to flow into the paper surface; accordingly, on the left side of FIG. 6, the current of the first coil winding 221 must flow into the paper surface, and the current of the second coil winding 222 must flow out of the paper surface. Therefore, magnitudes and directions of two forces respectively generated by the interaction between the magnetic field in the first annular gap 214 and the first coil winding 221, and the interaction between the magnetic fields in the second annular gap 215 and the second coil winding 222 are the same, but the present invention is not limited to this. Hence, said two forces are directed towards the diaphragm 11 to force the voice coil 22 to displace towards the diaphragm 11, thereby pushing the diaphragm 11.

In one embodiment, the directions of the N pole and the S pole of the above-mentioned magnetic flux conduction path are reversed, and the directions of the current passing through both the first coil winding 221 and the second coil winding 222 are also simultaneously reversed.

The distance between the indenting annular surface 212 of the magnetic flux conducting ring 21 and the top magnetic flux conducting plate 23, and the distance between the indenting annular surface 212 of the magnetic flux conducting ring 21 and the bottom magnetic flux conducting plate 25 are both greater than the width of the first annular gap 214 and the width of the second annular gap 215, such that the magnetic field lines can be concentrated in the first annular gap 214 and the second annular gap 215, and thereby magnitudes of the magnetic field in the first annular gap 214 and the second annular gap 215 are increased.

As can be seen from the above, the double gap double coil driven speaker 1 of the present invention adopts an innovative magnetic flux loop design, so that a single permanent magnet can generate two strong magnetic fields respectively in the first annular gap 214 and the second annular gap 215, so that the first coil winding 221 and the second coil winding 222 can be respectively disposed in the first annular gap 214 and the second annular gap 215 to nearly double the driving force of the voice coil 22. Compared with a conventional closed-circuit design of a speaker wherein a single permanent magnet is used to produce a single strong magnetic field in a single gap to suit a single coil, the double gap double coil driven speaker 1 of the present invention can increase the sound pressure by more than 4.6 dB (that is, volume the sound is increased) under the presumption that the coils are the same; and installation of two coils will not significantly increase the physical size of said double gap double coil driven speaker 1 of the present invention.

On top of that, a control unit (not shown in the drawings) may apply a current to both the first coil winding 221 and the second coil winding 222 in parallel, so that both the first coil winding 221 and the second coil winding 222 generate driving forces to move the voice coil 22 from an initial position towards the diaphragm 11, so that the top edge 223 of the voice coil 22 moves the junction of the wavy annular part 112 and the central bowl part 113 of the diaphragm 11, and then the central bowl part 113 of the diaphragm 11 is pushed forwardly to agitate the air to generate a sound; afterwards the control unit turns off the current applied to both the first coil winding 221 and the second coil winding 222, and the voice coil 22 is bounced back to the initial position due to the returning elastic force exerted by the stretched diaphragm 11. In the above-mentioned manner, a push on the diaphragm 11 is completed to generate a sound. If the above-mentioned push of the diaphragm 11 is repeated K times within 1 second, a sound with a dominant frequency of K can be generated. And the greater the driving forces generated by both the first coil winding 221 and the second coil winding 222, the louder the sound generated by the agitated diaphragm 11 will be.

In one embodiment, the first coil winding 221 and the second coil winding 222 are connected in series. Please refer to FIG. 6: the paper surface of FIG. 6 can be regarded as a common cross section of both the first annular gap 214 and the second annular gap 215. In this embodiment, with respect to said common cross section of said two gaps 214, 215, the directions of the currents respectively conducting in the first coil winding 221 and the second coil winding 222 are configured to be opposite to each other. The magnitudes and directions of two forces respectively generated by the interaction between the magnetic field in the first annular gap 214 and the first coil winding 221, and the interaction between the magnetic fields in the second annular gap 215 and the second coil winding 222 are the same, and said two forces are directed towards the diaphragm 11 to cause the voice coil 22 to displace towards the diaphragm 11, thereby pushing the diaphragm 11.

In one embodiment, the top edge 223 of the voice coil 22 and the junction of the wavy annular part 112 and the central bowl part 113 of the diaphragm 11 are fixed together to improve the control of the sound generation, but the present invention is not limited to this.

When the diaphragm 11 agitates the air to generate a sound, the sound will be propagated from the void 54 beside the connecting bars 53 of the fixing cap 5 to the outside of the fixing cap 5, and into the accommodating space 36 of the top shell cover 32, and then to the bottom of the top shell cover 32, and then through the void 34 between the plurality of connecting pieces 33 of the top shell 3, and finally to the outside of the top shell 3, and therefore the sound is propagated in a U-shaped path as shown by a flowline in FIG. 6. However, the present invention is not limited to this, and as a length of a propagation path of the sound generated by the diaphragm 11 is extended inside the double gap double coil driven speaker 1 of the present invention, the resonance of low-frequency sounds can be effectively increased, such that the sound of the double gap double coil driven speaker 1 of the present invention is less likely to be absorbed by the atmosphere, easier to bypass obstacles such as vehicles and buildings, able to transmit farther distances, and more easily to penetrate into the interiors of vehicles.

In sum, the physical size of the double gap double coil driven speaker of the present invention will not be significantly increased due to having two coils, nevertheless the sound volume of the double gap double coil driven speaker of the present invention can be significantly increased. The double gap double coil driven speaker of the present invention also prolongs the propagation path of the sound generated to improve the resonance of low-frequency sound, and thereby the double gap double coil driven speaker of the present invention can achieve the purposes of the present invention to provide targeted output sound volume with a constrained physical size.

What is claimed is:

1. A double gap double coil driven speaker, including:
a diaphragm;
a permanent magnet, having a magnetization;
a magnetic flux conducting device, having a magnetic flux conducting path, the magnetic flux conducting device and the permanent magnet together forming a magnetic flux loop; wherein the magnetic flux loop has two gaps, and directions of magnetic fields generated in the two gaps are opposite to each other;
a voice coil, having two coils wound on an outer surface of the voice coil, and the voice coil having one end connected to the diaphragm; wherein
the two coils are respectively accommodated in the two gaps; when the two coils conduct currents, the voice coil is displaced to push the diaphragm.

2. The double gap double coil driven speaker as claimed in claim 1, wherein relative to a common cross section of the two gaps, the currents respectively flowing through the two coils are in opposite directions.

3. The double gap double coil driven speaker as claimed in claim 1, wherein the magnetic flux conducting device includes:
a magnetic flux conducting ring having an inner ring side, wherein a first protruding annular surface, an indenting annular surface and a second protruding annular surface are disposed on the inner ring side in sequence, the first protruding annular surface is close to one end of the magnetic flux conducting ring, the second protruding annular surface is close to another end of the magnetic flux conducting ring, and the indenting annular surface is between the first protruding annular surface and the second protruding annular surface; and
a top magnetic flux conducting plate and a bottom magnetic flux conducting plate being disposed in the magnetic flux conducting ring, wherein a first annular gap is formed between the first protruding annular surface of the magnetic flux conducting ring and the top magnetic flux conducting plate, a second annular gap is formed between the second protruding annular surface of the magnetic flux conducting ring and the bottom magnetic flux conducting plate, and the first annular gap and the second annular gap constitute the two gaps.

4. The double gap double coil driven speaker as claimed in claim 3, wherein
the permanent magnet is disposed between the top magnetic flux conducting plate and the bottom magnetic flux conducting plate, and the voice coil is accommodated in a space between the magnetic flux conducting ring and the three of the top magnetic flux conducting plate, the permanent magnet, and the bottom magnetic flux conducting plate.

5. The double gap double coil driven speaker as claimed in claim 1, wherein
the diaphragm is in a shape of a round bowl and has a peripheral annular part, a wavy annular part and a central bowl part disposed in sequence from periphery to center, and the wavy annular part is wavy and elastic, the central bowl part has a bowl shape, and a junction of the wavy annular part and the central bowl part is connected with said one end of the voice coil.

6. The double gap double coil driven speaker as claimed in claim 5, further including:
a fixing cap having an annular border frame and a dome, and a void between the annular border frame and the dome of the fixing cap, and another end of the fixing cap being open; and
a fixing annular frame, which is a ring; wherein
the annular border frame and the dome of the fixing cap form an accommodating space, which is configured to accommodate the diaphragm, the fixing annular frame, the magnetic conducting device, the voice coil, and the permanent magnet in sequence.

7. The double gap double coil driven speaker as claimed in claim 6, wherein the peripheral annular part of the diaphragm is clamped between the annular border frame of the fixing cap and the fixing annular frame.

8. The double gap double coil driven speaker as claimed in claim 7, wherein the double gap double coil driven speaker further includes:
a top shell, wherein the top shell has a top shell frame and a top shell cover, the top shell frame is disposed on a periphery of the top shell, the top shell cover is disposed in the top middle of the top shell, and the top shell cover is a cylindrical shell with a closed end and an open end, a space is formed between the top shell cover and the top shell frame, and a void is between the closed end of the top shell cover and the top shell frame.

9. The double gap double coil driven speaker as claimed in claim 8, wherein the sound generated by the diaphragm is propagated to the closed end of the top shell cover through the void of the fixing cap, then to the open end of the top shell cover, then to the space between the top shell cover and the top shell frame, and finally to the void of the top shell.

10. The double gap double coil driven speaker as claimed in claim 1, wherein a product of air permeability and a sum of magnetic field strengths respectively generated in the two gaps is equivalent to magnetic flux density generated by the magnetization of the permanent magnet.

11. The double gap double coil driven speaker as claimed in claim 1, further including a U-shaped sound channel through which sound propagates to the outside.

12. The double gap double coil driven speaker as claimed in claim 2, further including a U-shaped sound channel through which sound propagates to the outside.

13. The double gap double coil driven speaker as claimed in claim 3, further including a U-shaped sound channel through which sound propagates to the outside.

14. The double gap double coil driven speaker as claimed in claim 4, further including a U-shaped sound channel through which sound propagates to the outside.

15. The double gap double coil driven speaker as claimed in claim 5, further including a U-shaped sound channel through which sound propagates to the outside.

16. The double gap double coil driven speaker as claimed in claim 6, further including a U-shaped sound channel through which sound propagates to the outside.

17. The double gap double coil driven speaker as claimed in claim 7, further including a U-shaped sound channel through which sound propagates to the outside.

18. The double gap double coil driven speaker as claimed in claim 8, further including a U-shaped sound channel through which sound propagates to the outside.

19. The double gap double coil driven speaker as claimed in claim 9, further including a U-shaped sound channel through which sound propagates to the outside.
